(19) United States
(12) Patent Application Publication
(10) Pub. No.: US 2011/0086258 A1
(43) Pub. Date: Apr. 14, 2011

(54) METHOD FOR MANUFACTURING SECONDARY BATTERY AND SECONDARY BATTERY

(76) Inventors: Hironori Yaginuma, Osaka (JP); Takashi Nonoshita, Wakayama (JP); Kiyomi Kozuki, Osaka (JP); Seiichi Kato, Osaka (JP)

(21) Appl. No.: 12/996,938

(22) PCT Filed: Aug. 24, 2009
(86) PCT No.: PCT/JP2009/004070

§ 371 Date: Dec. 8, 2010

(30) Foreign Application Priority Data
Aug. 25, 2008 (JP) 2008-214940
Sep. 26, 2008 (JP) 2008-247847
Sep. 30, 2008 (JP) 2008-253121

(51) Int. Cl. H01M 2/26; H01M 10/04; H01R 43/02

(52) U.S. Cl. 429/160; 29/623.1; 29/878

(57) ABSTRACT

A method includes: preparing an electrode group 4 in which a positive electrode 1 and a negative electrode 2 are arranged with a porous insulating layer interposed therebetween, with an end 1a, 2a of at least one of the positive and negative electrodes protruding from the porous insulating layer; preparing a current collector 10 on a first principal surface of which a plurality of protrusions having vertexes are formed; bringing the end 1a, 2a of the at least one of the positive and negative electrodes into contact with a second principal surface of the current collector 10; and generating an electric arc toward the vertexes of the protrusions 11 to melt the protrusions 11, thereby welding the end 1a, 2a of the at least one of the positive and negative electrodes to the current collector 10 by a molten material 12 of the protrusions 11.

### TECHNICAL FIELD

The present invention relates to a method for manufacturing a secondary battery including a so-called tabless electrode group, a current collector used in the method, and the secondary battery including the tabless electrode group.

### BACKGROUND ART

Due to the trend of downsizing of mobile electronic devices, lithium ion secondary batteries, and nickel metal hydride batteries have widely been used as power sources of the mobile electronic devices. In recent years, attention has been paid to these batteries as power sources of electric power tools, hybrid vehicles, etc., which require vibration resistance, and large current. Therefore, small, lightweight and high-power secondary batteries have been in demand for applications to devices of various forms, irrespective whether battery shape is cylindrical, or flat.

A tabless electrode group in which lateral ends of a positive electrode and a negative electrode are joined to current collectors, respectively, allows reduction of electrical resistance, and is suitable for large current discharge. In this case, however, the ends of the positive and negative electrodes have to be reliably joined to the current collector.

FIGS. 16(a) and 16(b) show the structure of a tabless electrode group described in Patent Document 1. FIG. 16(a) is a cross-sectional view of a current collector 60, and FIG. 16(b) is a cross-sectional view of the current collector 60 with an end of a positive electrode (or a negative electrode) 61 joined thereto.

As shown in FIG. 16(a), a plurality of grooves 60a are formed in a surface of the current collector 60. An end of a positive electrode (or a negative electrode) 61 is inserted in the grooves 60a, and the periphery of each groove 60a is molten to join the end of the positive electrode (or the negative electrode) 61 to the current collector 60 as shown in FIG. 16(b). In this case, the end of the positive electrode (or the negative electrode) 61 is welded while being embedded in metal which is a material of the current collector 60 at a joint 62 between the end and the current collector 60. Thus, the end of the positive electrode (or the negative electrode) 61 can reliably be joined to the current collector 60.

However, according to the above-described method, the grooves 60a have to be formed in the current collector 60 to correspond to the layout of the positive electrode (or the negative electrode) 61. Further, the end of the positive electrode (or the negative electrode) 61 has to be aligned with the grooves 60a. This complicates the manufacturing process, thereby increasing manufacture cost.

Patent Document 2 describes an easy method for joining the end of the positive electrode (or the negative electrode) to the current collector without such alignment.

FIG. 17 is a cross-sectional view illustrating the structure of a secondary battery described in Patent Document 2. As shown in FIG. 17, an end 71a of a positive electrode 71 and an end 72a of a negative electrode 72 protruding from a separator 73 in opposite directions are joined to a current collector 70 and a current collector 74, respectively. The ends 71a and 72a of the positive and negative electrodes 71 and 72 are pressed by the current collectors 70 and 74 to form flat portions, and the flat portions are in contact with, and are welded to the current collectors 70 and 74. Thus, the alignment is not required.

According to the above-described method, however, when current collector bodies constituting the positive and negative electrodes 71 and 72 are thinned (e.g., to a thickness of 20 μm or smaller), mechanical strength of the current collector bodies is reduced. As a result, the uniformly bent flat portions cannot be formed easily even if the ends 71a and 72a of the positive and negative electrodes 71 and 72 are pressed.

Patent Documents 3 and 4 describe a technology which allows joining of the end of the positive or negative electrode to the current collector even when the current collector body constituting the positive or negative electrode is thinned.

FIG. 18 is a perspective view illustrating the structure of the current collector described in Patent Document 3. As shown in FIG. 18, a first raised portion 80a and a second raised portion 80b protruding in opposite directions are formed on surfaces of a flat current collector 80. With an end of a positive electrode (or a negative electrode) 81 kept in contact with the second raised portion 80b, energy is applied to the first raised portion 80a to melt the first raised portion 80a, part of a body of the current collector 80, and the second raised portion 80b, thereby joining the end of the positive electrode (or the negative electrode) 81 to the current collector 80. In this case, the end of the positive electrode (or the negative electrode) 81 can be joined to the current collector 80 by a molten material of the current collector 80 by merely bringing the end of the positive electrode (or the negative electrode) 81 into contact with the second raised portion 80b of the current collector 80. Thus, even when a current collector body constituting the positive electrode (or the negative electrode) 81 is thinned, and the mechanical strength is reduced, the end of the positive electrode (or the negative electrode) 81 can be joined to the current collector 80 without applying any load to the current collector body.

FIG. 19 is a perspective view illustrating the structure of a current collector described in Patent Document 4. As shown in FIG. 19, a current collector 90 includes corrugated parts 90a, and a groove 90b penetrating the current collector in a thickness direction. An end of a positive electrode (or a negative electrode) 91 is converged toward the corrugated part 90a, and the periphery of the groove 90b is molten to join the end of the positive electrode (or the negative electrode) 91 to the current collector 90. In this case, the end can be joined to the current collector 90 by a molten material of the current collector 90 by merely converging the end of the positive electrode (or the negative electrode) 91 toward the corrugated part 90a. Therefore, even when a current collector body constituting the positive electrode (or the negative electrode) 91 is thinned, and the mechanical strength is reduced, the end of the positive electrode (or the negative electrode) 91 can be joined to the current collector 90 without applying any load to the current collector body.

### CITATION LIST

### Patent Document

[Patent Document 1] Japanese Patent Publication No. 2006-172780
[Patent Document 2] Japanese Patent Publication No. 2000-294222
[Patent Document 3] Japanese Patent Publication No. 2004-172038
[Patent Document 4] Japanese Patent Publication No. 2003-36834

### SUMMARY OF THE INVENTION

### Technical Problem

According to the conventional technology described in Patent Documents 3 and 4, however, it is difficult to precisely melt an intended portion of the current collector (the first raised portion 80a in Patent Document 3, and the periphery of the groove 90b in Patent Document 4). Therefore, when a portion misaligned from the intended portion is molten, the electrode group or the separator below the current collector may thermally be damaged.

In view of the foregoing, the present invention has been achieved. A principal object of the invention is to provide a secondary battery including an electrode group in which the ends of the positive and negative electrodes are stably joined to the current collectors.

### Solution to the Problem

A method for manufacturing a secondary battery according to a first aspect of the invention includes: (a) preparing an electrode group in which a positive electrode and a negative electrode are arranged with a porous insulator interposed therebetween, with an end of at least one of the positive electrode and the negative electrode protruding from the porous insulating layer; (b) preparing a current collector on a first principal surface of which a plurality of protrusions having vertexes are formed; (c) bringing the end of the at least one of the positive electrode and the negative electrode protruding from the porous insulating layer into contact with a second principal surface of the current collector; and (d) generating an electric arc toward the vertexes of the protrusions to melt the protrusions, thereby welding the end of the at least one of the positive electrode and the negative electrode to the current collector by a molten material of the protrusions.

With this configuration, in welding the end of the electrode to the current collector by the electric arc, the vertexes of the protrusions function as antennas, thereby allowing the electric arc to generate toward the vertexes of the protrusions. As a result, a path of a welding current generated by the electric arc can reliably be guided to the protrusions to be molten, thereby precisely melting the protrusions only. Thus, the ends of the positive and negative electrodes can stably be joined to the current collectors without thermally damaging the electrode group and the separator below the current collectors.

According to a preferred embodiment, in preparing the current collector (b), pairs of projections are formed on the second principal surface, and each of the protrusions formed on the first principal surface of the current collector is positioned between each of the pairs of projections, in bringing the end into contact with the second principal surface (c), the end of the at least one of the positive electrode and the negative electrode is converged between the pair of projections, and is brought into contact with the second principal surface of the current collector, and in welding (d), the end of the at least one of the positive electrode and the negative electrode which is converged between the pair of projections is welded to the current collector by the molten material of the protrusions.

With this configuration, the ends of the positive and negative electrodes converged between the corresponding pairs of projections can reliably be welded to the corresponding current collectors by melting the projections positioned between the corresponding pairs of projections.

### ADVANTAGES OF THE INVENTION

According to the present invention, the vertexes of the protrusions functions as antennas in welding the end of the electrode to the current collector by the electric arc, thereby allowing the electric arc to generate toward the vertexes of the protrusions. As a result, a path of a welding current generated by the electric arc can reliably be guided to the protrusions to be molten, thereby precisely melting the protrusions only. Thus, a secondary battery including an electrode group in which ends of a positive electrode and a negative electrode are stably joined to current collectors can be provided without thermally damaging the electrode group and a separator.

### BRIEF DESCRIPTION OF THE DRAWINGS

FIGS. 1(a)-1(c) schematically show the structure of an electrode group of an embodiment of the present invention, in which FIG. 1(a) is a plan view of a positive electrode, FIG. 1(b) is a plan view of a negative electrode, and FIG. 1(c) is a perspective view of the electrode group.

FIGS. 2(a)-2(b) schematically show the structure of a current collector of the embodiment of the present invention, in which FIG. 2(a) is a perspective view of the current collector, and FIG. 2(b) is a cross-sectional view taken along the line 11b-Hb shown in FIG. 2(a).

FIGS. 3(a)-3(c) are cross-sectional views schematically illustrating the steps of joining the electrode group to the current collector.

FIG. 4 is a cross-sectional view schematically illustrating the structure of a secondary battery of the embodiment of the present invention.

FIG. 5 is a perspective view illustrating another structure of the current collector of the embodiment of the present invention.

FIGS. 6(a)-6(c) are cross-sectional views illustrating another structures of protrusions formed on the current collector of the embodiment of the present invention.

FIG. 7 is a cross-sectional view illustrating a method for converging an end of a positive electrode toward a protrusion.

FIG. 8 is a plan view illustrating the structure of the current collector of the embodiment of the present invention.

FIGS. 9(a)-9(b) are cross-sectional views illustrating a method for manufacturing the current collector of the embodiment of the present invention.

FIG. 10 is a cross-sectional view illustrating the structure of a current collector provided with protrusions and pairs of projections by casting.

FIG. 11 is a cross-sectional view illustrating another method for converging an end of a positive electrode 1 toward a protrusion.

FIG. 12 is a perspective view illustrating the structure of a stacked electrode group and a current collector of the embodiment of the present invention.

FIG. 13 is a perspective view illustrating the structure of a flat wound electrode group and a current collector of the embodiment of the present invention.

FIGS. 14(a)-14(c) are plan views illustrating the layout of protrusions formed on a current collector.

FIG. 15 is a perspective view illustrating how a stacked electrode group is joined to a current collector.

FIGS. 16(a)-16(b) show the structure of a conventional tabless electrode group, in which FIG. 16(a) is a cross-sectional view of a current collector, and FIG. 16(b) is a cross-sectional view illustrating an end of a positive electrode (or a negative electrode) joined to the current collector.

FIG. 17 is a cross-sectional view illustrating the structure of a conventional secondary battery.

FIG. 18 is a perspective view illustrating the structure of a conventional current collector.

FIG. 19 is a perspective view illustrating the structure of a conventional current collector.

### DESCRIPTION OF EMBODIMENT

An embodiment of the present invention will be described with reference to the drawings. The present invention is not limited to the following embodiment. The embodiment can be modified without deviating from the scope of the present invention, and can be combined with other embodiments.

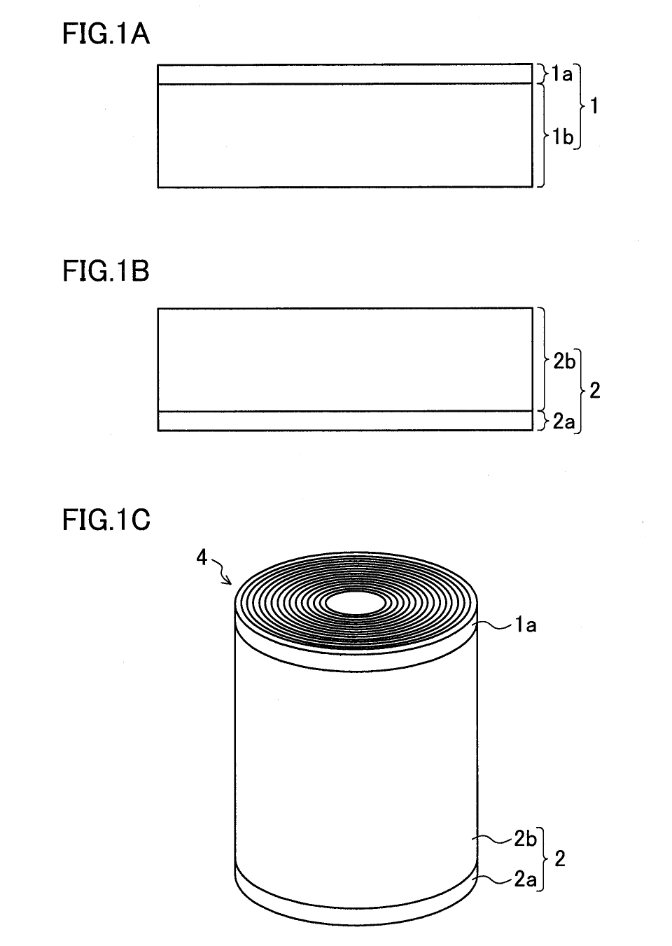

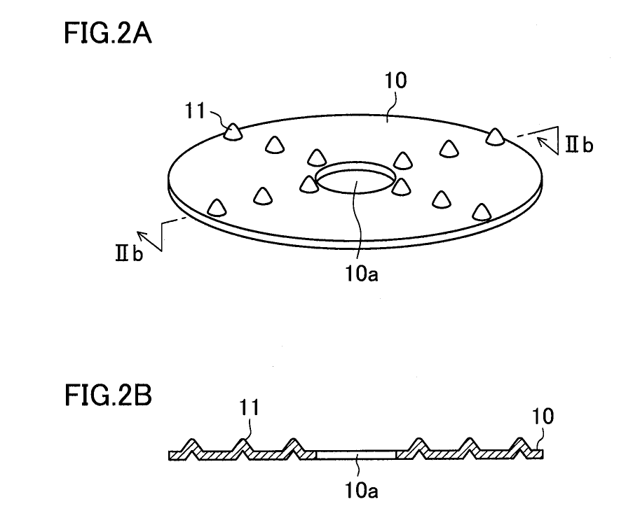

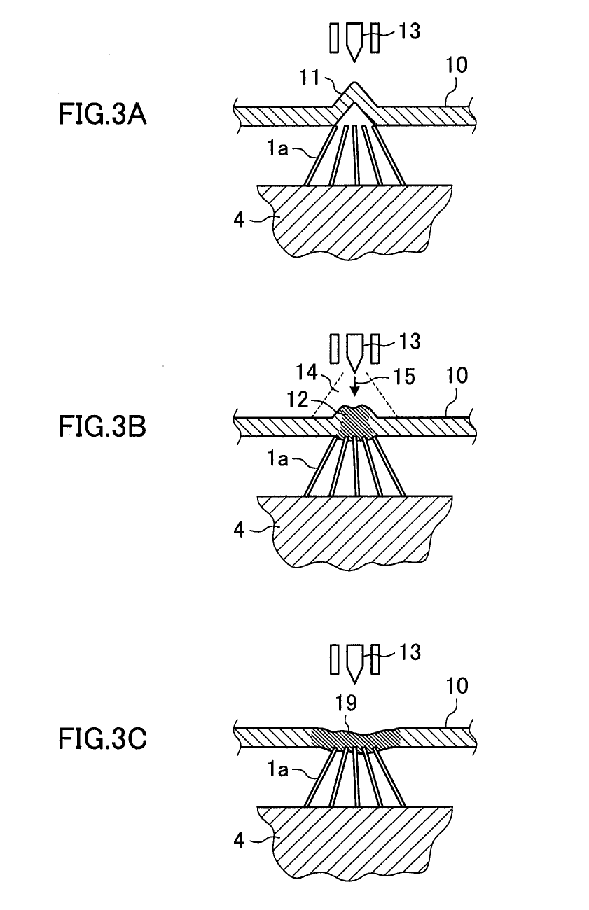

FIGS. 1-3 show a method for manufacturing a secondary battery according to an embodiment of the present invention. FIGS. 1(a)-1(c) schematically show the structure of an electrode group 4. FIG. 1(a) is a plan view of a positive electrode 1, FIG. 1(b) is a plan view of a negative electrode 2, and FIG. 1(c) is a perspective view of the electrode group 4. FIGS. 2(a)-2(b) schematically show the structure of a current collector 10. FIG. 2(a) is a perspective view of the current collector 10, and FIG. 2(b) is a cross-sectional view taken along the line IIb-IIb shown in FIG. 2(a). FIGS. 3(a)-3(c) are cross-sectional views schematically illustrating the steps of joining the electrode group 4 to the current collector 10. In the following description, a positive electrode will be described as an example when the polarity of the electrode is not mentioned.

First, as shown in FIG. 1(c), an electrode group 4 is prepared in which a positive electrode 1 and a negative electrode 2 are arranged with a porous insulating layer (not shown) interposed therebetween, with ends 1a and 2a of the positive and negative electrodes 1 and 2 protruding from the porous insulating layer. The end 1a of the positive electrode 1 is a non-coated portion on which a positive electrode material mixture layer 1b is not formed as shown in FIG. 1(a). The end 2a of the negative electrode is a non-coated portion on which a negative electrode material mixture layer 2b is not formed as shown in FIG. 1(b). As shown in FIGS. 2(a) and 2(b), a current collector 10 is prepared, on a surface (a first principal surface) of which a plurality of protrusions 11 having vertexes, respectively, are formed. The shape of the protrusions 11 is not limited as long as they have vertexes. For example, the protrusion may preferably be in the shape of a cone, a pyramid, etc. As shown in FIG. 2(b), each of the protrusions 11 having the vertexes may have hollow space inside. As shown in FIG. 2(a), the protrusions 11 having the vertexes, respectively, are preferably formed radially on the first principal surface of the current collector 10. If a hole 10a is formed in the center of the current collector 10, an electrolyte solution can easily be injected through the hole 10a after the electrode group joined to the current collector 10 is placed in a battery case.

Then, as shown in FIG. 3(a), the end 1a of the positive electrode 1 protruding from the porous insulating layer (not shown) is brought into contact with a second principal surface of the current collector 10. The end 1a of the positive electrode 1 is preferably converged toward the protrusion 11 by the method described below.

Then, as shown in FIG. 3(b), an electric arc is generated toward the vertex of the protrusion 11 to melt the protrusion 11. Specifically, an electrode rod 13 is brought near the protrusion 11 surrounded by inert gas atmosphere 14, and a high voltage is applied between the electrode rod 13 and the current collector 10 to generate the electric arc toward the vertex of the protrusion 11. After the electric arc is generated, a welding current 15 is controlled, thereby melting the protrusion 11. The electric arc is generally generated toward a tip of a protrusion near the electrode rod 13. Therefore, even when the electrode rod 13 is misaligned from the protrusion 11 to some extent, the vertex of the protrusion 11 acts as an antenna of the electric arc. This allows reliable generation of the electric arc toward the protrusion 11.

A molten material 12 of the protrusion 11 having the vertex flows through the center of the protrusion 11, and covers the end 1a of the positive electrode 1. Thus, as shown in FIG. 3(c), the end 1a of the positive electrode 1 and the current collector 10 can be welded at a joint 19.

Thus, with the protrusion 11 having the vertex provided on the first principal surface of the current collector 10, a path of the welding current generated by the electric arc can reliably be guided to the protrusion to be molten, thereby precisely melting the protrusion only. Therefore, the ends of the positive and negative electrodes can stably be joined to the current collectors without thermally damaging the electrode group and the separator below the current collectors.

Examples of the welding using the electric arc (arc welding) include tungsten inert gas (TIG) welding, MIG welding, MAG welding, CO₂ arc welding, etc.

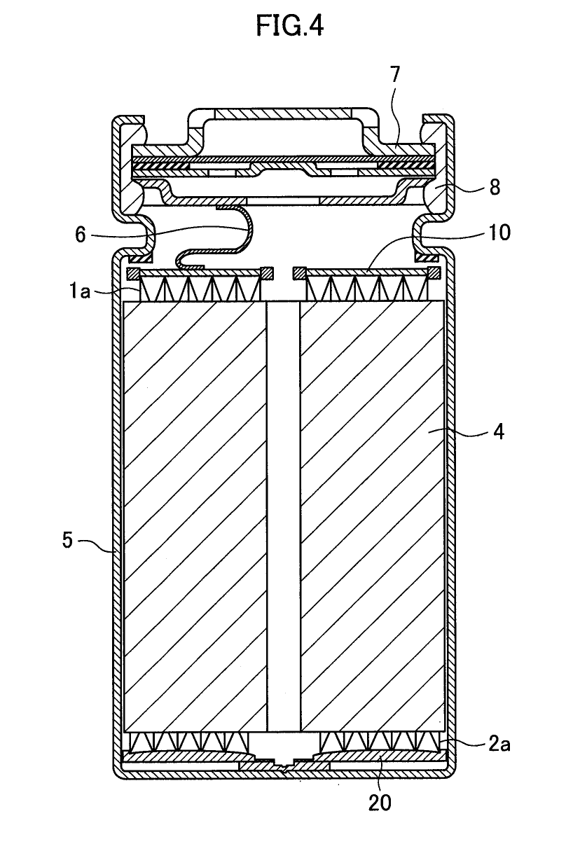

FIG. 4 is a cross-sectional view schematically illustrating the structure of a secondary battery of the present embodiment. An electrode group 4 in which the end 1a of the positive electrode 1 and the end 2a of the negative electrode 2 are welded to a positive electrode current collector 10 and a negative electrode current collector 20 by the above-mentioned method, respectively, is contained in a battery case 5 together with an electrolyte solution. The positive electrode current collector 10 is connected to a sealing plate 7 through a positive electrode lead 6, and the negative electrode current collector 20 is connected to a bottom surface of the battery case 5. An opening of the battery case 5 is sealed by the sealing plate 7 including a gasket 8 at an outer edge thereof.

In the cylindrical secondary battery shown in FIG. 4, the current collector 10 is generally round as shown in FIG. 2(a). However, as shown in FIG. 5, notches 10b may be formed in parts of the current collector 10 where the protrusions 11 having the vertexes are not formed. This configuration allows easy injection of the electrolyte solution through the notches 10b after the electrode group joined to the current collector 10 is placed in the battery case.

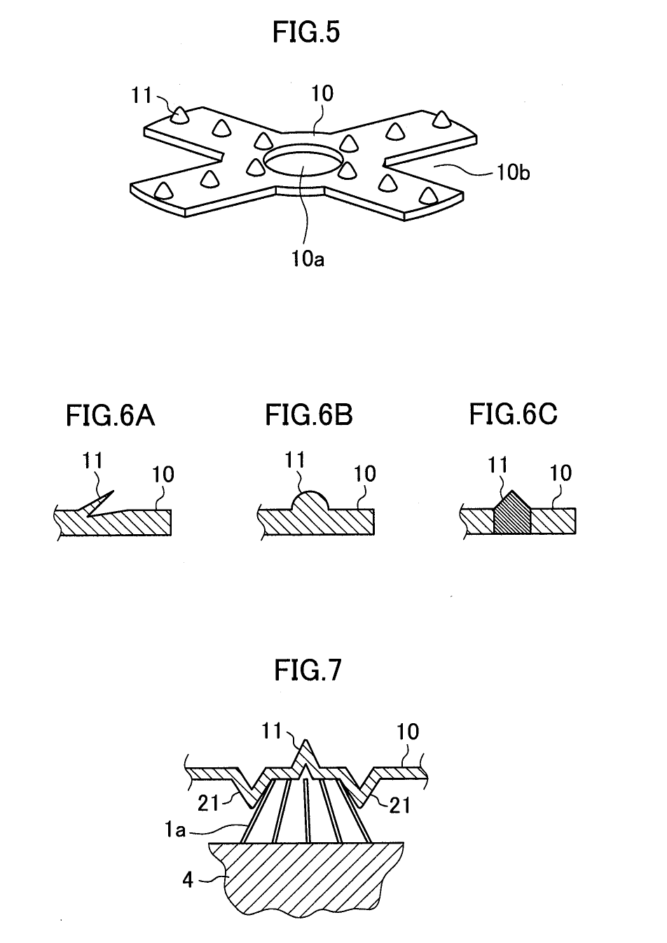

The protrusions 11 which are formed on the current collector 10, and have the vertexes may be formed integrally with the current collector 10 by pressing, forging, etc. The protrusions may also be formed as shown in FIGS. 6(a)-6(c). An example of the protrusion 11 shown in FIG. 6(a) is formed by cutting and raising a surface of the current collector 10 by a cutter etc. An example of the protrusion 11 shown in FIG. 6(b) is formed by extrusion. An example of the protrusion 11 shown in FIG. 6(c) is formed by fitting a metal material having a lower melting point than the current collector 10 in a through hole formed in the current collector 10. For example, when the positive electrode current collector 10 is made of aluminum, an aluminum alloy, nickel-plated steel sheet, nickel, or a nickel alloy, the protrusions 11 may be made of brazing aluminum alloy, brazing silver, brazing nickel, etc. When the negative electrode current collector 20 is made of copper, a copper alloy, nickel-plated steel sheet, nickel, or a nickel alloy, the protrusions 11 may be made of brazing phosphor copper, brazing copper, brazing nickel, etc.

FIG. 7 is a cross-sectional view illustrating a method for converging the end 1a of the positive electrode 1 toward the protrusion 11. As shown in FIG. 7, pairs of projections 21 are formed on a back surface (the second principal surface) of the current collector 10, and each of the protrusions 11 formed on the front surface (the first principal surface) of the current collector 10 is positioned between each of the pairs of projections 21. When the end 1a of the positive electrode 1 is in contact with the current collector 10 configured as described above, the end 1a of the positive electrode 1 is guided by sidewalls of the pair of projections 21, and is converged between the pair of projections. Then, the electric arc is generated toward the vertex of the protrusion 11 to melt the protrusion 11. As a result, since the protrusion 11 having the vertex is positioned between the pair of projections 21, the end 1a of the positive electrode 1 converged between the pair of projections 21 is welded to the current collector 10 by the molten material of the protrusion 11. Thus, the end 1a of the positive electrode 1 converged between the pair of projections 21 can reliably be joined to the current collector 10.

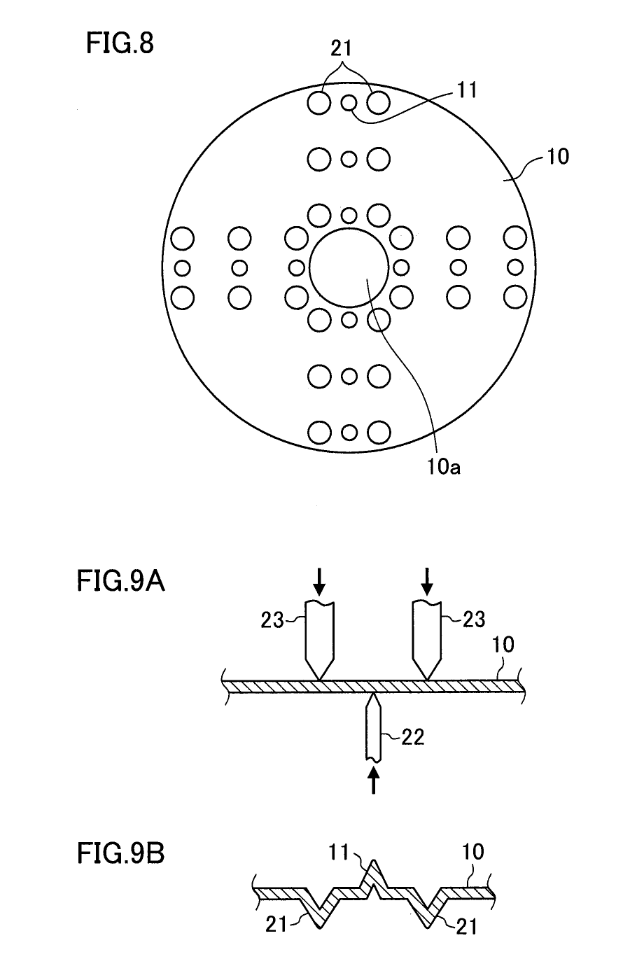

FIG. 8 is a plan view illustrating the structure of the current collector 10 described above. The pairs of projections 21 (projecting downward in the figure) are radially arranged on the back surface of the current collector 10. The protrusions 11 (protruding upward in the figure) are radially arranged on the front surface of the current collector 10 to be positioned between the pairs of projections 21, respectively.

The protrusion 11 having the vertex is preferably positioned in the middle of the pair of projections 21, but is not always limited to the position. Two or more protrusions 11 having the vertexes may be arranged between each of the pairs of projections 21. The protrusions 11 and the pairs of projections 21 do not always have the same size and shape, and their sizes and shapes may be determined based on the intended joint. A distance between the pair of projections 21 is not particularly limited. However, for example, the pair of projections 21 may have a distance which allows 3-15 ends 1a of the positive electrode 1 to be converged therebetween. The term “vertex” referred in the present invention is a tip which is sharpened to such a degree that the tip can function as an antenna for the electric arc. The vertex is not always pointed, but may be rounded.

FIGS. 9(a)-9(b) are cross-sectional views illustrating an example of a method for manufacturing the current collector 10 shown in FIG. 7. As shown in FIG. 9(a), a punch 22 for forming the protrusions 11 is arranged on the back surface of the flat current collector 10, and a pair of punches 23 for forming the pairs of projections 21 is arranged on the front surface of the current collector 10. The punch 22 and the pair of punches 23 are pressed in the directions shown in FIG. 9(a) to bend the current collector 10. Thus, the protrusions 11 and the pairs of projections 21 are formed integrally with the current collector 10 as shown in FIG. 9(b).

The current collector 10 can be formed by casting. FIG. 10 is a cross-sectional view illustrating the structure of the current collector 10 on which the projections 11 and the pairs of projections 21 are formed by casting. In this case, different from the protrusions 11 and the pairs of projections 21 formed by bending, hollow space is not formed in each of the protrusions 11 and the pairs of projections 21 as shown in FIG. 10.

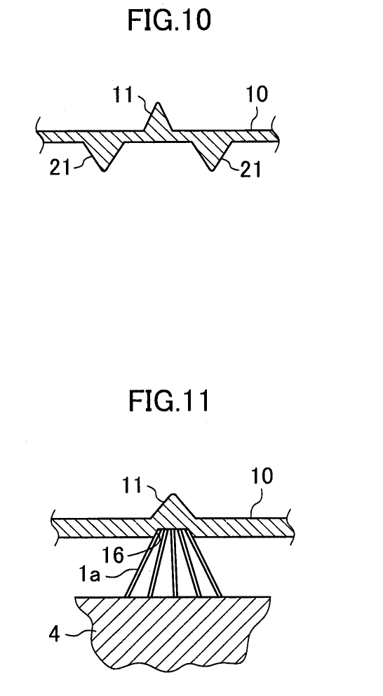

FIG. 11 is a cross-sectional view illustrating another method for converging the end 1a of the positive electrode 1 toward the protrusions 11. A groove 16 for converging the end 1a of the positive electrode 1 is formed in the back surface of the current collector 10 (a surface opposite the surface on which the protrusions 11 are formed). The groove 16 for converging the end 1a of the positive electrode 1 can be formed by, for example, pressing a cutter on the back surface, or cutting the back surface using a lathe. The end 1a of the positive electrode 1 is fitted in the groove 16, thereby converging the end 1a.

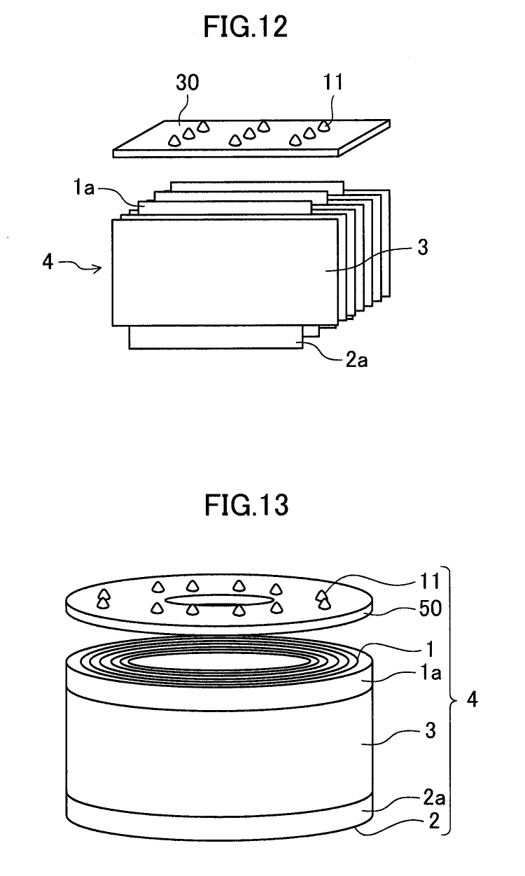

FIG. 12 is a perspective view illustrating the structure of an electrode group 4 including a positive electrode 1 and a negative electrode 2 which are stacked with a porous insulating layer 3 interposed therebetween, and a current collector 30. The stacked electrode group 4 is placed in a rectangular battery case, thereby constituting a rectangular secondary battery. As shown in FIG. 12, the current collector 30 has substantially the same rectangular shape as the battery case. A plurality of protrusions 11 are formed on a surface of the current collector 30 to be aligned in a stacking direction of the positive electrode 1 and the negative electrode 2.

FIG. 13 is a perspective view illustrating the structure of a flat electrode group 4 including a positive electrode 1 and a negative electrode 2 which are wound with a porous insulating layer 3 interposed therebetween, and a current collector 50. The flat wound electrode group 4 is placed in a rectangular battery case, thereby constituting a rectangular secondary battery. As shown in FIG. 13, the current collector 50 is oval-shaped, and a plurality of protrusions 11 are formed on a surface of the current collector 50 to be aligned in a long axis direction and/or a short axis direction of the oval-shaped current collector 50.

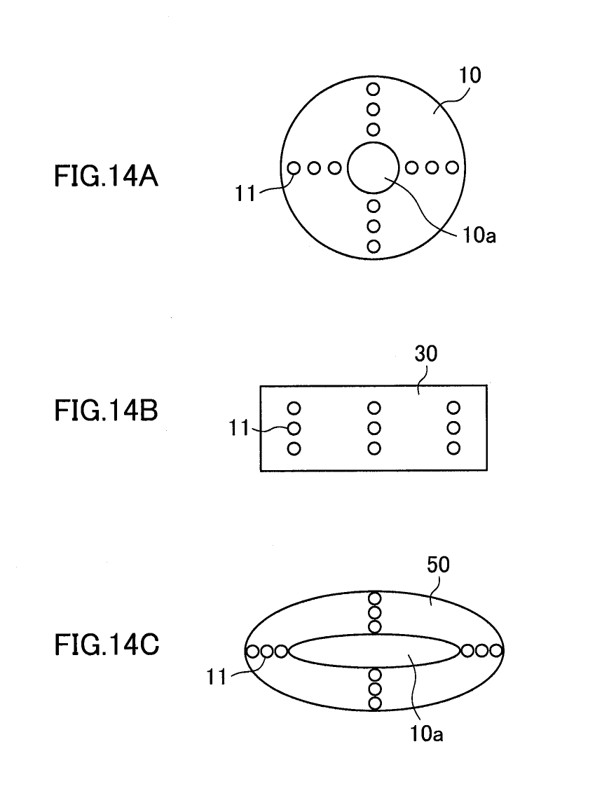

FIGS. 14(a)-14(c) are plan views illustrating the layout of protrusions 11 formed on a current collector. FIG. 14(a) shows the current collector 10 to be joined to the cylindrical wound electrode group 4 (see FIG. 1(c)), FIG. 14(b) shows the current collector 30 to be joined to the stacked electrode group 4 (see FIG. 12), and FIG. 14(c) shows the current collector 50 to be joined to the flat wound electrode group 4, with the layouts of the protrusions 11 formed on the current collectors 10, 30, and 50, respectively.

As shown in FIG. 14(a), the protrusions 11 are preferably radially formed on the current collector 10 to be joined to the cylindrical electrode group 4. In this case, the positive electrode 1 and the negative electrode 2 are wound into spiral, and the end 1a of the positive electrode 1 is generally perpendicular to all the protrusions 11. Therefore, the end 1a of the positive electrode 1 can reliably be joined to the current collector 10 by melting the protrusions 11.

As shown in FIG. 14(b), on the current collector 30 to be joined to the stacked electrode group 4, the protrusions 11 are preferably to be aligned in the stacking direction of the positive electrode 1 and the negative electrode 2. In this case, the end 1a of the positive electrode 1 is generally perpendicular to all the protrusions 11. Therefore, the end 1a of the positive electrode 1 can reliably be joined to the current collector 30 by melting the protrusions 11.

As shown in FIG. 14(c), on the current collector 50 to be joined to the flat wound electrode group 4, the protrusions 11 are preferably aligned in the long axis direction and the short axis direction of the current collector 50. In this case, the end 1a of the positive electrode 1 is generally perpendicular to all the protrusions 11. Therefore, the end 1a of the positive electrode 1 can reliably be joined to the current collector 50 by melting the protrusions 11.

The present invention can be applied to secondary batteries, to a lithium ion secondary battery described in the following examples, and to nickel metal hydride batteries. Examples of the lithium ion secondary battery to which the present invention has been applied will be described below.

### Example 1

### (1) Manufacture of Positive Electrode

Eighty-five parts by weight (pbw) of lithium cobaltate powder was prepared as a positive electrode active material, 10 pbw of carbon powder was prepared as a conductive agent, and 5 pbw of polyvinylidene fluoride (PVdF) was prepared as a binder. The prepared positive electrode active material, conductive agent, and binder were mixed to form a positive electrode material mixture.

The positive electrode material mixture was applied to each surface of a positive electrode current collector body made of aluminum foil of 15 μm in thickness, and 56 mm in width, and the positive electrode material mixture was dried. Then, a positive electrode material mixture layer 1b formed by applying the positive electrode material mixture was rolled to form a 150 μm thick positive electrode 1. The positive electrode material mixture layer 1b had a width of 50 mm, and a non-coated portion 1a on which the positive electrode material mixture was not applied had a width of 6 mm.

### (2) Manufacture of Negative Electrode

Ninety-five pbw of artificial graphite powder was prepared as a negative electrode active material, and 5 pbw of PVdF was prepared as a binder. The prepared negative electrode active material and binder were mixed to form a negative electrode material mixture.

The negative electrode material mixture was applied to each surface of a negative electrode current collector body made of copper foil of 10 μm in thickness, and 57 mm in width, and the negative electrode material mixture was dried. Then, a negative electrode material mixture layer 2b formed by applying the negative electrode material mixture was rolled to form a 160 μm thick negative electrode 2. The negative electrode material mixture layer 2b had a width of 52 mm, and a non-coated portion 2a on which the negative electrode material mixture was not applied had a width of 5 mm.

### (3) Manufacture of Electrode Group

A separator 3 made of a microporous film of polypropylene resin having a width of 53 mm, and a thickness of 25 μm was interposed between the positive electrode material mixture layer 1b and the negative electrode material mixture layer 2b. Then, the positive electrode 1, the negative electrode 2, and the separator 3 were wound into spiral to constitute an electrode group 4.

### (4) Manufacture of Current Collector

A 0.8 mm thick aluminum plate was pressed. Thus, the aluminum plate was shaped into a disc, and protrusions 11 each having a height of 0.5 mm, a central angle of 60°, and a substantially V-shaped cross section, were formed at an interval of 3 mm in a radial direction of the aluminum plate.

The aluminum plate was punched to form a hole 10a having a diameter of 7 mm in the center of the disc-shaped aluminum plate. The aluminum plate had a diameter of 30 mm. Thus, a positive electrode current collector 10 was formed.

A 0.6 mm thick, copper negative electrode current collector 20 was formed in the same manner.

### (5) Manufacture of Current Collecting Structure

The positive electrode current collector 10 and the negative electrode current collector 20 were brought into contact with end faces of the electrode group 4, and an end (a non-coated portion) 1a of the positive electrode 1 was welded to the positive electrode current collector 10, and an end (a non-coated portion) 2a of the negative electrode 2 was welded to the negative electrode current collector 20, by TIG welding. Thus, the current collecting structure was formed.

The TIG welding for welding the positive electrode current collector 10 was performed at a current value of 150 A for a welding time of 50 ms. The TIG welding for welding the negative electrode current collector 20 was performed at a current value of 100 A for a welding time of 50 ms.

### (6) Manufacture of Cylindrical Lithium Ion Secondary Battery

The current collecting structure was inserted in a cylindrical battery case 5 having an opening at only one end. Then, the negative electrode current collector 20 was resistance-welded to the battery case 5, and the positive electrode current collector 10 and a sealing plate 7 were laser-welded through an aluminum positive electrode lead 6 with an insulator interposed therebetween.

Ethylene carbonate and ethyl methyl carbonate were mixed in a volume ratio of 1:1 to prepare a nonaqueous solvent, and lithium hexafluorophosphate (LiPF₆) as a solute was dissolved in the nonaqueous solvent to prepare a nonaqueous electrolyte.

The battery case 5 was heated to dry, and then the nonaqueous electrolyte was injected in the battery case 5. Then, the battery case 5 was crimped onto the sealing plate 7 with a gasket 8 interposed therebetween to manufacture a cylindrical lithium ion secondary battery having a diameter of 26 mm, and a height of 65 mm (Sample 1). Sample 1 had a battery capacity of 2600 mAh.

### Example 2

### (1) Manufacture of Positive Electrode

Eighty-five pbw of lithium cobaltate powder was prepared as a positive electrode active material, 10 pbw of carbon powder was prepared as a conductive agent, and 5 pbw of polyvinylidene fluoride (PVdF) was prepared as a binder. The prepared positive electrode active material, conductive agent, and binder were mixed to form a positive electrode material mixture.

The positive electrode material mixture was applied to each surface of a positive electrode current collector body made of aluminum foil of 15 μm in thickness, and 83 mm in width. After the positive electrode material mixture was dried, a positive electrode material mixture layer 1b was rolled to form an 83 μm thick positive electrode 1. The positive electrode material mixture layer 1b had a width of 77 mm, and a non-coated portion 1a on which the positive electrode material mixture was not applied had a width of 6 mm.

### (2) Manufacture of Negative Electrode

Ninety-five pbw of artificial graphite powder was prepared as a negative electrode active material, and 5 pbw of PVdF was prepared as a binder. The prepared negative electrode active material and binder were mixed to form a negative electrode material mixture.

The negative electrode material mixture was applied to each surface of a negative electrode current collector body made of copper foil of 10 μm in thickness, and 85 mm in width. After the negative electrode material mixture was dried, a negative electrode material mixture layer 2b was rolled to form a 100 μm thick negative electrode 2. The negative electrode material mixture layer had a width of 80 mm, and a non-coated portion 2a on which the negative electrode material mixture was not applied had a width of 5 mm.

### (3) Manufacture of Electrode Group

A microporous film made of polypropylene resin having a width of 81 mm, and a thickness of 25 μm was prepared as a separator 3. The separator 3 was interposed between the positive electrode 1 and the negative electrode 2. Then, the positive electrode 1, the negative electrode 2, and the separator 3 were stacked to constitute an electrode group 4.

### (4) Manufacture of Current Collector

An aluminum plate having a thickness of 0.8 mm, a width of 8 mm, and a length of 55 mm was pressed to form protrusions 11 each having a height of 0.5 mm, a central angle of 60°, and a substantially V-shaped cross section on a surface of the aluminum plate. Thus, a positive electrode current collector 10 was formed.

A 0.6 mm copper negative electrode current collector 20 was formed in the same manner.

### (5) Manufacture of Current Collecting Structure

The positive electrode current collector 10 and the negative electrode current collector 20 were brought into contact with end faces of the electrode group 4, and an end (a non-coated portion) 1a of the positive electrode 1 was welded to the positive electrode current collector 10, and an end (a non-coated portion) 2a of the negative electrode 2 was welded to the negative electrode current collector 20, by TIG welding. Thus, the current collecting structure was formed.

The TIG welding for welding the positive electrode current collector 10 was performed at a current value of 150 A for a welding time of 50 ms. The TIG welding for welding the negative electrode current collector 20 was performed at a current value of 100 A for a welding time of 50 ms.

### (6) Manufacture of Rectangular Lithium Ion Secondary Battery

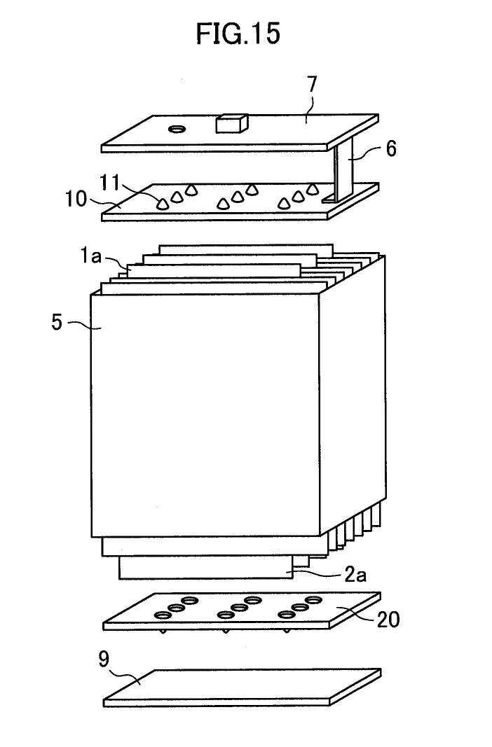

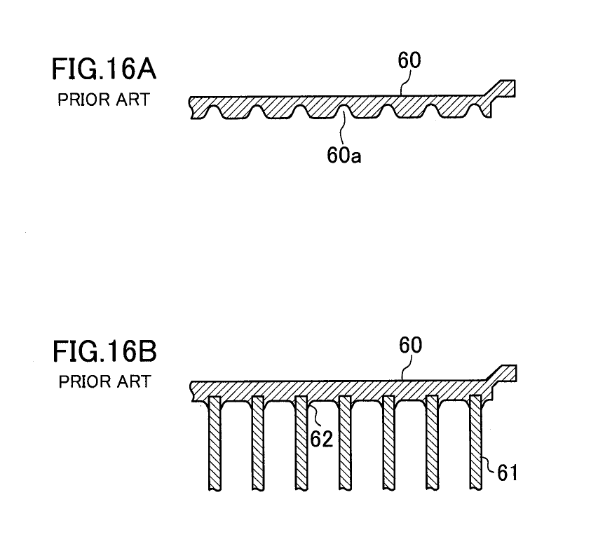

A rectangular battery case 5 having openings at both ends was prepared. Then, as shown in FIG. 15, the formed current collecting structure was placed in the battery case 5 with the positive electrode current collector 10 and the negative electrode current collector 20 protruding from the openings.

The negative electrode current collector 20 was resistance-welded to a flat plate as a bottom plate 9 of the battery case 5, and was placed in the battery case 5. Then, the bottom plate 9 was laser-welded to the battery case 5, thereby sealing the bottom of the battery case 5. Likewise, the positive electrode current collector 10 was laser-welded to a sealing plate 7, and was placed in the battery case 5 with a positive electrode lead 6 folded.

Then, the sealing plate 7 was laser-welded to the battery case 5, thereby attaching the sealing plate 7 to an upper opening of the battery case 5. An injection hole provided in the sealing plate 7 was not sealed.

Ethylene carbonate and ethyl methyl carbonate were mixed at a volume ratio of 1:1 to prepare a nonaqueous solvent. Lithium hexafluorophosphate (LiPF₆) was dissolved in the nonaqueous solvent to prepare a nonaqueous electrolyte.

The battery case 5 was heated to dry, the nonaqueous electrolyte was injected in the battery case 5 through the injection hole, and then the injection hole was hermetically sealed. Thus, a rectangular lithium ion secondary battery having a thickness of 10 mm, a width of 58 mm, and a height of 100 mm (Sample 2) was formed. Sample 2 had a battery capacity of 2600 mAh.

### Comparative Example 1

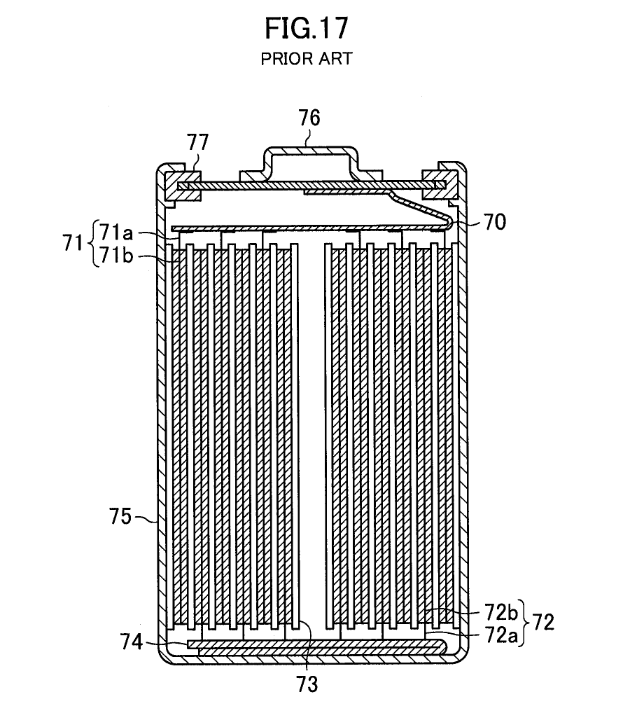

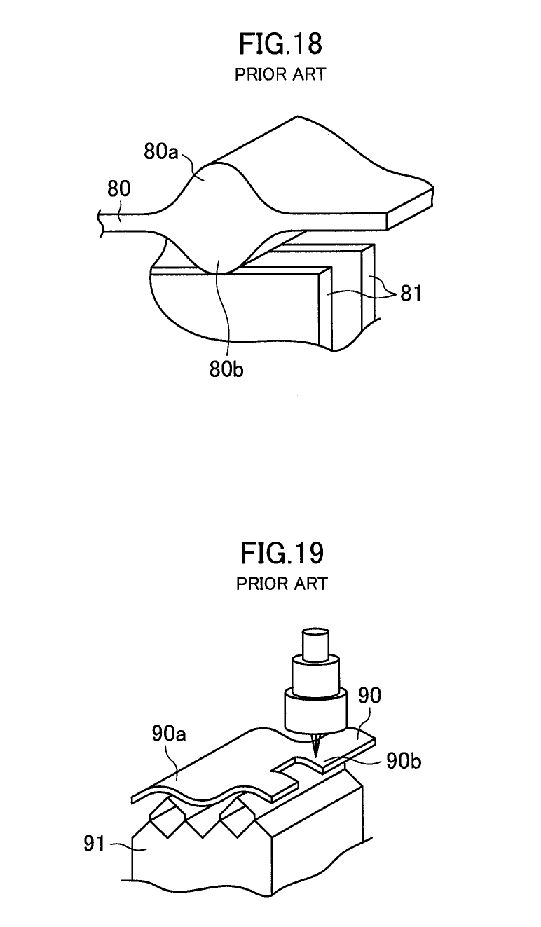

A lithium ion secondary battery of Comparative Example 1 shown in FIG. 17 was formed.

Specifically, a positive electrode 71 and a negative electrode 72 similar to those of Example 1 were wound with a separator 73 interposed therebetween to constitute an electrode group. An end (a non-coated portion) 71a of the positive electrode 71, and an end (a non-coated portion) 72a of the negative electrode 72 were pressed in a direction of a winding axis to form flat surfaces.

The flat surface formed at the end 71a of the positive electrode 71 was brought into contact with an aluminum positive electrode current collector 70 having a thickness of 0.5 mm, and a diameter of 24 mm, and was TIG-welded to the positive electrode current collector 70. Likewise, the flat surface formed at the end 72a of the negative electrode 72 was brought into contact with a copper negative electrode current collector 74 having a thickness of 0.3 mm, and a diameter of 24 mm, and was TIG-welded to the negative electrode current collector 74.

The positive electrode current collector 70 and the negative electrode current collector 74 were TIG-welded at a current of 100 A for 100 ms. Using the current collecting structure formed as described above, a cylindrical lithium ion secondary battery (Sample 3) was formed in the same manner as described in Example 1.

### Comparative Example 2

A lithium ion secondary battery of Comparative Example 2 shown in FIG. 19 was formed.

Specifically, an aluminum plate having a thickness of 0.5 mm, a width of 8 mm, and a length of 55 mm was pressed to form raised portions 90a each having a height of 1 mm, an angle of 120°, and a substantially V-shaped cross section, on a surface of the aluminum plate to be aligned parallel to each other at an interval of 2 mm.

Then, the aluminum plate was partially cut in a lateral direction to form a groove 90b, thereby constituting a positive electrode current collector 90. A 0.3 mm copper negative electrode current collector was formed in the same manner.

The positive electrode current collector 90 and the negative electrode current collector formed as described above were used to form a rectangular lithium ion secondary battery (Sample 4) in the same manner as described in Example 2.

Fifty lithium ion secondary batteries of Samples 1-4 were prepared, and were evaluated as described below.

(A) Visual Check of Joint between End of Electrode and Current Collector

The electrode group was removed from the battery case of the formed lithium ion secondary battery, and a joint was visually checked. Table 1 shows the results.

TABLE 1

| | | | | Tensile | Internal | |
|---|---|---|---|---|---|---|
| | Battery | | | strength | resistance | Output |
| | Shape | Joint | Electrode | (rate of break) | (variations) | current |
| Example 1 | Cylindrical | Good | Good | ≧50N | 5 mΩ | 540 A |
| (Sample 1) | | | | | (9%) | |
| Example 2 | Rectangular | Good | Good | ≧50N | 5 mΩ | 540 A |
| (Sample 2) | | | | | (10%) | |
| Example 3 | Cylindrical | Hole was | Material | ≦10N | 13 mΩ | 207 A |
| (Sample 3) | | found in | mixture was | (80%) | (30%) | |
| | | joint | peeled | | | |
| Example 4 | Rectangular | Current | Good | ≦10N | 18 mΩ | 150 A |
| (Sample 4) | | collector | | (40%) | (30%) | |
| | | was damaged | | | | |

As shown in Table 1, in Samples 1 and 2, a hole was not found in the joint, and the current collector body (the electrode) was not damaged. However, in Sample 3, the hole in the joint was found in some of the lithium ion secondary batteries. A presumable cause of the generation of the hole is that the flat surfaces at the end of the positive electrode and the end of the negative electrode were not stably in contact with the current collector. In Sample 4, the current collector body was damaged in every lithium ion secondary battery. In some of the batteries of Sample 4, molten metal did not reach the end face of the electrode group.

### (B) Check of Bending of Electrode

The electrode group was removed from the battery case of the formed lithium ion secondary battery as described above, and the electrode was visually checked. Table 1 shows the results.

As shown in Table 1, bending of the electrode group which causes the material mixture layer to become warped was hardly found in Samples 1 and 2. In both of Samples 1 and 2, the material mixture layer was not peeled from the current collector body, and the material mixture layer was not damaged.

In Sample 3, the material mixture layer was peeled in many cases. The material mixture layer was presumably peeled when the end of the electrode was pressed to form the flat surface. Sample 4 did not show the bending of the current collector.

### (C) Measurement of Tensile Strength

Five batteries of each Sample were examined to measure tensile strength at the joint based on JIS Z2241. Specifically, with the electrode group held at one end of a tensile strength tester, and the current collector held at the other end of the tensile strength tester, the electrode group and the current collector were pulled at a constant speed in an axial direction of the tensile strength tester (directions in which the electrode group and the current collector are separated from each other), and a load with which the joint was broken was measured as the tensile strength. Table 1 shows the measurement results.

As shown in Table 1, batteries of Samples 1 and 2 showed a tensile strength of 50 N or higher. Four of five batteries of Sample 3 showed a tensile strength of 10 N or lower, and experienced break of the joint. Three of five batteries of Sample 4 showed a tensile strength of 10N or lower, and experienced break of the joint.

### (D) Measurement of Internal Resistance

Internal resistance was measured in each of Samples. Specifically, each of Samples was charged at a constant current of 1250 mA to 4.2 V, and was discharged at a constant current of 1250 mA to 3.0 V. This charge/discharge cycle was repeated three times. Then, an alternating current of 1 kHz was applied to measure the internal resistance of the secondary battery. Table 1 shows the measurement results.

As shown in Table 1, Samples 1 and 2 showed an average internal resistance value of 5 mΩ, with variations of about 10%. Sample 3 showed an average internal resistance value of 13 mΩ, with variations of 30%. Sample 4 showed an average internal resistance value of 18 mΩ, with variations of not lower than 30%.

An average output current (I) was calculated from the internal resistance measurement (R) of each Sample. When the battery is charged to a voltage of 4.2 V, and is discharged to a voltage of 1.5 V, the output current (I) is obtained from V/R=2.7 V/internal resistance based on R (resistance)×I (current)=V (voltage). Table 1 shows the calculation results.

Table 1 indicates that Samples 1 and 2 allow large current discharge.

The present invention has been described by way of an embodiment. However, the present invention is not limited by the description of the embodiment, and can be modified in various ways. For example, as an example of the above-described embodiment, a rectangular lithium ion secondary battery has been described in which a stacked electrode group is placed in a rectangular battery case having openings at both ends. However, the electrode group may be wound into a flat shape, or the electrode group may be accordion-folded. The electrode group may be placed in a flat battery case having an opening only at one end to constitute a lithium ion secondary battery.

### INDUSTRIAL APPLICABILITY

The present invention is useful for secondary batteries having a current collecting structure suitable for large current discharge, and can be applied to, for example, a driving power source of electric power tools, electric vehicles, etc., which requires high power, and a large-capacity backup power source, a storage power source, etc.

### DESCRIPTION OF REFERENCE CHARACTERS

1 Positive electrode
1a End of positive electrode (non-coated portion)
1b Positive electrode material mixture layer
2 Negative electrode
2a End of negative electrode (non-coated portion)
2b Negative electrode material mixture layer
3 Separator (porous insulating layer)
4 Electrode group
5 Battery case
6 Positive electrode lead
7 Sealing plate
8 Gasket
9 Bottom plate
10 Positive electrode current collector
10a Hole
10b Notch
11 Protrusion
12 Molten material
13 Electrode rod
15 Welding current
16 Groove
19 Joint
20 Negative electrode current collector
21 Projection
22, 23 Punch
30, 50 Current collector

1. A method for manufacturing a secondary battery including an electrode group in which a positive electrode and a negative electrode are arranged with a porous insulating layer interposed therebetween, the method comprising:
(a) preparing the electrode group in which the positive electrode and the negative electrode are arranged with the porous insulator interposed therebetween, with an end of at least one of the positive electrode and the negative electrode protruding from the porous insulating layer;
(b) preparing a current collector on a first principal surface of which a plurality of protrusions having vertexes are formed;
(c) bringing the end of the at least one of the positive electrode and the negative electrode protruding from the porous insulating layer into contact with a second principal surface of the current collector; and
(d) generating an electric arc toward the vertexes of the protrusions to melt the protrusions, thereby welding the end of the at least one of the positive electrode and the negative electrode to the current collector by a molten material of the protrusions.

2. The method for manufacturing the secondary battery of claim 1, wherein
the current collector prepared in the (b) preparing includes pairs of projections which are formed on the second principal surface, and each of the protrusions formed on the first principal surface of the current collector is positioned between each of the pairs of projections,
in the (c) bringing, the end of the at least one of the positive electrode and the negative electrode is converged between the pair of projections, and is brought into contact with the second principal surface of the current collector, and
in the (d) welding, the end of the at least one of the positive electrode and the negative electrode which is converged between the pair of projections is welded to the current collector by the molten material of the protrusions.

3. The method for manufacturing the secondary battery of claim 1, wherein
each of the protrusions of the current collector prepared in the (b) preparing is in the shape of a cone, or a pyramid.

4. The method for manufacturing the secondary battery of claim 1, wherein
the plurality of projections of the current collector prepared in the (b) preparing are radially arranged on the first principal surface of the current collector.

5. The method for manufacturing the secondary battery of claim 1, wherein
the protrusions of the current collector prepared in the (b) preparing are formed integrally with the current collector by pressing the current collector made of a flat plate.

6. The method for manufacturing the secondary battery of claim 2, wherein
the protrusions and the pairs of projections of the current collector prepared in the (b) preparing are formed integrally with the current collector by pressing the current collector made of a flat plate.

7. The method for manufacturing the secondary battery of claim 1, wherein
each of the protrusions of the current collector prepared in the (b) preparing has hollow space inside.

8. The method for manufacturing the secondary battery of claim 1, wherein
the protrusions of the current collector prepared in the (b) preparing are made of a metal material having a lower melting point than a material of the current collector.

9. The method for manufacturing the secondary battery of claim 1, wherein
the end of the at least one of the positive electrode and the negative electrode in the electrode group (a) prepared in the (a) preparing is a non-coated portion on which a material mixture layer is not formed.

10. A current collector used in the method for manufacturing the secondary battery of any one of claims 1 to 9, wherein
a plurality of protrusions having vertexes are formed on a first principal surface of the current collector.

11. The current collector of claim 10, wherein
pairs of projections are formed on a second principal surface of the current collector, and
each of the protrusions is positioned between each of the pairs of projections.

12. The current collector of claim 10, wherein
each of the protrusions is in the shape of a cone, or a pyramid.

13. A secondary battery manufactured by the method of any one of claims 1 to 9, wherein
an end of at least one of a positive electrode and a negative electrode protrudes from a porous insulating layer, and the protruding end is in contact with a second principal surface of the current collector, and is welded to the current collector, and
the end of the at least one of a positive electrode and a negative electrode is welded to the current collector by a material of protrusions which are formed on a first principal surface of the current collector, and have vertexes, the material being molten by an electric arc generated toward the vertexes of the protrusions.

14. The secondary battery of claim 13, wherein
pairs of projections are formed on the second principal surface of the current collector, and
the end of the at least one of a positive electrode and a negative electrode is converged between each of the pairs of projections, and is welded to the current collector by a molten material of the protrusions each of which is positioned between each of the pairs of projections.
